(19) United States
(12) Patent Application Publication
(10) Pub. No.: US 2014/0198526 A1
(43) Pub. Date: Jul. 17, 2014

(54) LIGHT GUIDE PLATE AND LIGHTING LAMP

(71) Applicant: SHENZHEN ONWING OPTOELECTRONICS PRODUCTS CO., LTD, Shenzhen, Guangdong (CN)

(72) Inventors: Xi Liu, Shenzhen, Guangdong (CN); Junxiong Nie, Shenzhen, Guangdong (CN)

(73) Assignee: SHENZHEN ONWING OPTOELECTRONICS PRODUCTS CO., LTD, Shenzhen, Guangdong (CN)

(21) Appl. No.: 14/343,338

(22) PCT Filed: Feb. 1, 2013
(86) PCT No.: PCT/CN2013/071279

§ 371 Date: Mar. 6, 2014

(30) Foreign Application Priority Data
Jul. 3, 2012 (CN) 201220316342.0

(51) Int. Cl. F21V 8/00

(52) U.S. Cl. CPC G02B 6/0075
USPC 362/611; 362/616

(57) ABSTRACT

A light guide plate (LGP) and a lighting lamp including the LGP. The LGP has no frame and is easy to be spliced together. The LGP includes at least one sub-LGP. The sub-LGP includes at least one light source portion that is opposite to the light source, and at least one light shield installation slot that is sunken inwards and arranged beside the light source portion.

### TECHNICAL FIELD

The utility model relates to lighting field, specifically to a light guide plate and lighting lamp.

### BACKGROUND

The light guide plate is usually used for liquid crystal display to uniformly conduct and emit light emitted from the light source. Because the light guide plate is of good optical conductivity, it is also used in lighting lamp for light conduction. However, the existing light guide plate is always a whole integrated body. In order to use it for bigger lighting lamp, there is also light guide plate made by splicing multiple light guide plates together. When it is used for liquid crystal display or lighting lamp, the light source 92 is generally placed at lateral side of the light guide plate 91, with a structure as shown in FIG. 15. In order to avoid light leakage, a light shield 93 is generally arranged outside of the light source 92 to cover the light source 92 and partially shield front and back sides of the light guide plate. However, these proposals have the following disadvantages:

1. The light shield extends out of the light guide plate at the light emitting plane, so it appears as a frame which reduces the light emitting plane and influences the aesthetic appearance.

2. For the bigger lighting lamp, such as outdoor advertisement backlight screen, although the light conduction can be realized by means of splicing multiple light guide plates together, due to structure of the light guide plate and the light shield, it is difficult to splice them together or avoid gaps among the multiple light guide plates.

### SUMMARY OF THE UTILITY MODEL

In the existing technology, the light shield extends out of the light guide plate at the light emitting plane and appears as a frame which reduces the light emitting plane and influences the aesthetic appearance, and it is difficult to splice them together or avoid gaps among the multiple light guide plates due to structure of the light guide plate and the light shield. In order to solve the above technical problems, the utility model claims a light guide plate and lighting lamp.

In order to solve the above technical problems, the technical proposal of the utility model is to provide a light guide plate, comprising at least one sub-LGP, wherein the sub-LGP comprises at least one light source portion that is opposite to the light source, and the sub-LGP further comprises at least one light shield installation slot that is sunken inwards and arranged beside the light source portion.

The light source portion and the light shield installation slot are arranged at the lateral side of the sub-LGP.

There are at least two light shield installation slots that are respectively arranged at two sides of the light source portion.

There are at least two light source portions that are arranged at the sub-LGP side, and there are at least three light shield installation slots that are respectively arranged outside of the two light source portions and between the two light source portions.

A light source slot, which is vertically sunken inwards, is arranged at middle of the upper surface of the sub-LGP, the light source portion is arranged at lateral side of the light source slot, and the light shield installation slots are horizontally arranged at bottom of the light source slot.

The light guide plate is formed by splicing the sub-LGPs.

The light guide plate comprises at least two different kinds of sub-LGPs.

The utility model further provides a lighting lamp, comprising a light source, wherein the lighting lamp further comprises the above light guide plate, and the light source is opposite to the light source portion.

The lighting lamp further comprises a light shield that is opposite to the light source portion and covers the light source, and the light shield comprises a light shield edge that is matched with and inserted into the light shield installation slot.

The utility model further provides a lighting lamp, comprising a light source and a light guide plate, wherein the light guide plate comprises at least one sub-LGP which comprises at least one light source portion that is opposite to the light source, and the sub-LGP further comprises at least one light shield installation slot that is sunken inwards and arranged beside the light source portion; a light source slot, which is vertically sunken inwards, is arranged at middle of the upper surface of the sub-LGP, the light source portion is arranged at lateral side of the light source slot, and the light shield installation slots are horizontally arranged at bottom of the light source slot; the light guide plate is formed by splicing the sub-LGPs; the light source is opposite to the light source portion; the lighting lamp further comprises a frame, and a vertical supporting edge that is inserted into the light source slot and a light shield edge that is matched with and inserted into the light shield installation slot and arranged at bottom of the supporting edge are arranged at center of the bottom of the frame; the supporting edge, the light shield edge and bottom of the frame form the light shield that covers the light source.

In the utility model, the light guide plate comprises at least one sub-LGP, and a light shield installation slot is arranged on the sub-LGP. In actual use, one edge of the light shield is inserted into the light shield installation slot, thus the light shield of the lighting lamp does not extend out of the light guide plate, so the light guide plate does not have any frame, which results in better appearance and light emitting effect. Because of the light shield installation slot, when it is necessary to splice the sub-LGPs together, it is only necessary to sleeve the light shield installation slot of each sub-LGP onto the light shield, which makes the splicing much easier; besides, different kinds of sub-LGPs can also be spliced together without any gap therebetween.

### BRIEF DESCRIPTION OF THE DRAWINGS

The following is the detailed description of the utility model in combination with the embodiments and drawings.

FIG. 1 is the structure diagram of the sub-LGP in embodiment 1 of the utility model;

FIG. 2 is the structure diagram of the sub-LGP in FIG. 1 being applied to lighting lamp;

FIG. 3 is the structure diagram of the sub-LGP in embodiment 2 of the utility model;

FIG. 4 is the structure diagram of the sub-LGP in embodiment 3 of the utility model;

FIG. 5 is the structure diagram of the sub-LGP in embodiment 4 of the utility model;

FIG. 6 the structure diagram of the sub-LGP in FIG. 5 being applied to lighting lamp;

FIG. 7 is the structure diagram of the sub-LGP in embodiment 5 of the utility model;

FIG. 8 is the structure diagram of the sub-LGP in embodiment 6 of the utility model; FIG. 9 the structure diagram of the sub-LGP in FIG. 8 being applied to lighting lamp;

FIG. 10 is the structure diagram of one embodiment of the lighting lamp of the utility model;

FIG. 11 is the explosive view of FIG. 10;

FIG. 12 is the structure diagram of the sub-LGP in embodiment 7 of the utility model;

FIG. 13 is the structure diagram of the sub-LGP in embodiment 8 of the utility model;

FIG. 14 is the structure diagram of the sub-LGP in embodiment 9 of the utility model;

FIG. 15 is the structure diagram of the existing lighting lamp.

### DETAILED DESCRIPTION OF THE PREFERRED EMBODIMENTS

### Embodiment 1

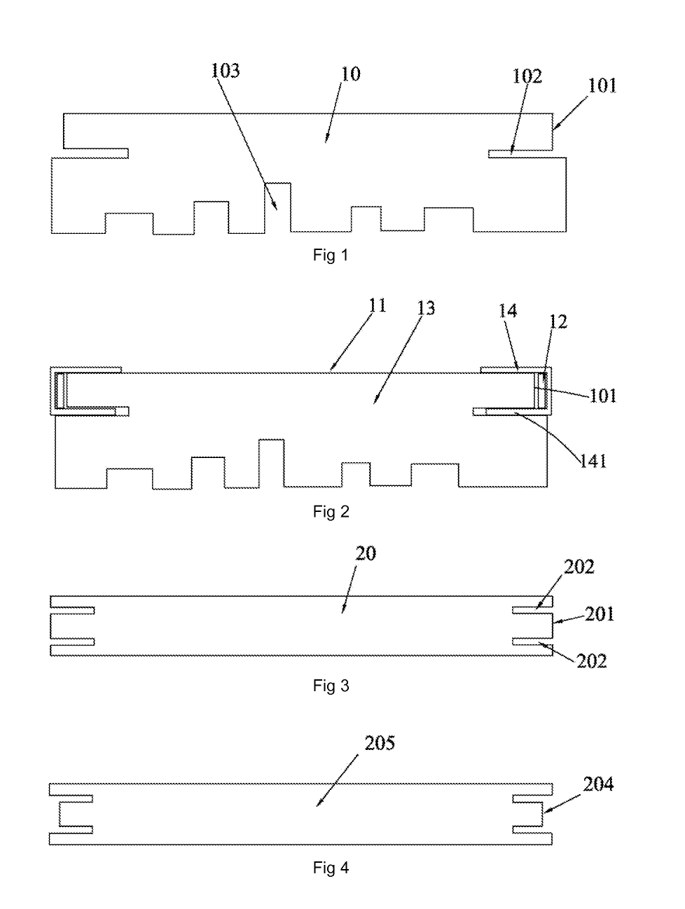

As shown in FIG. 1, the light guide plate comprises at least one sub-LGP 10 which comprises at least one light source portion 101 that is opposite to the light source and at least one light shield installation slot 102 that is sunken inwards and arranged beside the light source portion. The light source portion and the light shield installation slot are arranged at two lateral sides of the sub-LGP. In this embodiment, the light shield installation slot 102 is arranged under the light source portion. Also, the light source portion and the light shield installation slot can be arranged at only one lateral side of the sub-LGP, so light can only enter from one single side. Further, the light source portion and the light shield installation slot can be arranged at four lateral sides of the sub-LGP, so light can enter from four sides.

As shown in FIG. 2, the lighting lamp 11 comprises a light source 12, a light guide plate 13 and a light shield 14, wherein the light guide plate comprises at least one sub-LGP 10. The light source 12 is opposite to the light source portion 101. The light shield 14 is opposite to the light source portion and covers the light source. And the light shield 14 comprises a light shield edge 141 that is matched with and inserted into the light shield installation slot.

The light guide plate is formed by splicing the sub-LGPs together. Because of the light shield installation slot, when it is necessary to splice the sub-LGPs together, it is only necessary to sleeve the light shield installation slot of each sub-LGP onto the light shield, which makes the splicing much easier; besides, different kinds of sub-LGPs can also be spliced together without any gap therebetween. The light guide plate can be formed by splicing same or at least two different kinds of sub-LGPs together. The sub-LGP can be in different structures, for example, regular shapes like rectangle, triangle and semicircle and irregular shapes, so as to realize different lighting effects. For example, as shown in FIG. 1, a sunken square slot 103 is arranged on the light emitting plane of the light guide plate.

### Embodiment 2

As shown in FIG. 3, similar to embodiment 1, the sub-LGP 20 which forms the light guide plate also comprises a light source portion 201 and a light shield installation slot 202, and the light source portion and the light shield installation slot are arranged at two lateral sides of the sub-LGP. The difference is arrangement of the light shield installation slot 202. In this embodiment, there are four light shield installation slots respectively arranged at two lateral sides of the two light source portions. Further, the light source portion and the light shield installation slot can be arranged at only one lateral side of the sub-LGP, so light can only enter from one single side. At this time, there are two light shield installation slots respectively arranged at two lateral sides of the light source portion.

### Embodiment 3

As shown in FIG. 4, the difference between this embodiment and the embodiment 2 is that the light source portion 204 is slightly sunken to the lateral side of the light guide plate 205.

### Embodiment 4

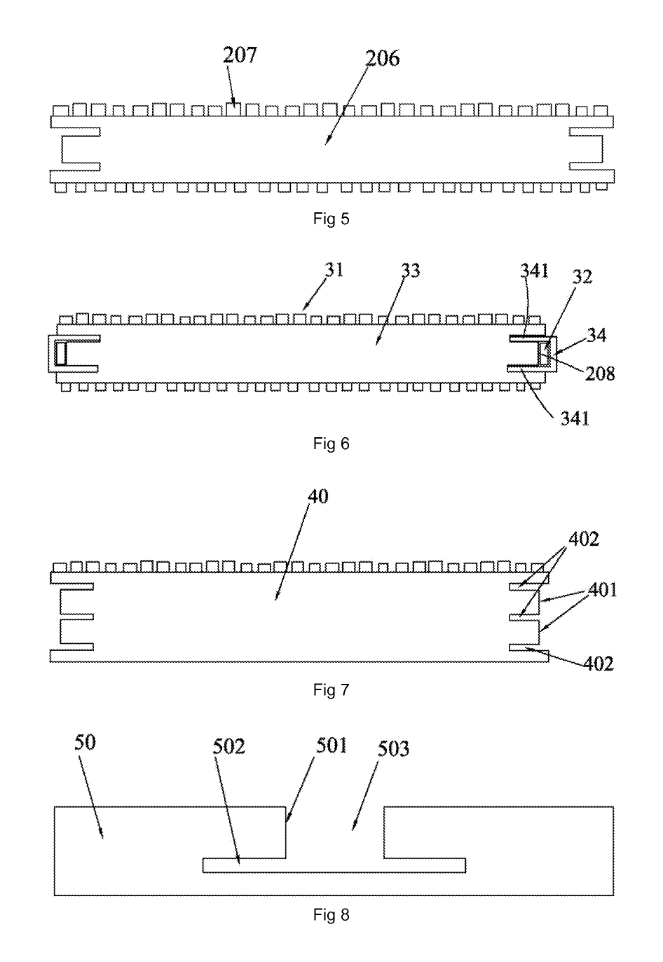

As shown in FIG. 5, the difference between this embodiment and the embodiment 3 is that the sub-LGP 206 which forms the light guide plate is provided with light conduction points 207 at the upper and lower surfaces thereof As shown in FIG. 6, the lighting lamp 31 comprises a light source 32, a light guide plate 33 and a light shield 34, wherein the light guide plate comprises at least one sub-LGP 206. The light source 32 is opposite to the light source portion 208. The light shield 34 is opposite to the light source portion and covers the light source. And the light shield 34 comprises a light shield edge 341 that is matched with and inserted into the light shield installation slot. In this embodiment, because the light shield installation slots are arranged at two lateral sides of the light source portion, there should be two light shield edges accordingly.

The light guide plate is formed by splicing the sub-LGPs together. Because of the light shield installation slot, when it is necessary to splice the sub-LGPs together, it is only necessary to sleeve the light shield installation slot of each sub-LGP onto the light shield, which makes the splicing much easier; besides, different kinds of sub-LGPs can also be spliced together without any gap therebetween. The light guide plate can be formed by splicing same or at least two different kinds of sub-LGPs together. The sub-LGP can be in different structures to realize different lighting effects.

### Embodiment 5

As shown in FIG. 7, in this embodiment, the sub-LGP 40 which forms the light guide plate also comprises a light source portion 401 and a light shield installation slot 402, and the light source portion and the light shield installation slot are arranged at two lateral sides of the sub-LGP. The difference between this embodiment and the embodiment 1 is that multiple light source portions and light shield installation slots are arranged at one lateral side of the sub-LGP. In this embodiment, there are two light source portions 401 that are arranged at one lateral side of the sub-LGP, and there are three light shield installation slots that are respectively arranged outside of the two light source portions and between the two light source portions.

In this embodiment, the light source at same side of the sub-LGP 40 can be of different colors, so as to realize light emitting effect of different color on the upper and lower surfaces of the sub-LGP 40. For example, the light source at the upper portion is red while the light source at the lower surface is blue; after mixing light, the upper surface emits more red light while the lower surface emits more blue light, thus to realize light emitting of different colors on the upper and lower surfaces of the sub-LGP.

### Embodiment 6

As shown in FIG. 8, in this embodiment, the sub-LGP 50 which forms the light guide plate also comprises a light source portion 501 and a light shield installation slot 502. A light source slot 503, which is vertically sunken inwards, is arranged at middle of the upper surface of the sub-LGP 50, the light source portion 501 is arranged at lateral side of the light source slot, and the light shield installation slots 502 are horizontally arranged at bottom of the light source slot.

As shown in FIG. 9, the lighting lamp 51 comprises a light source 52, a light guide plate 53 and a light shield 54, wherein the light guide plate comprises at least one sub-LGP 50. The light source 52 is opposite to the light source portion 501. The light shield 54 is opposite to the light source portion and covers the light source. And the light shield 54 comprises a light shield edge 541 that is matched with and inserted into the light shield installation slot.

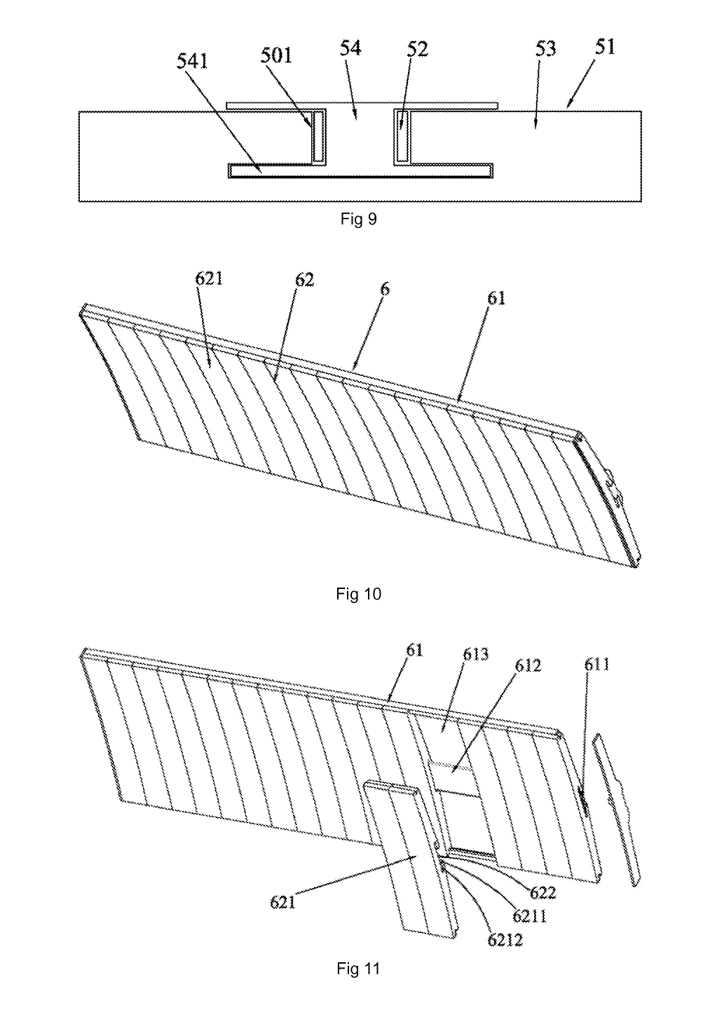

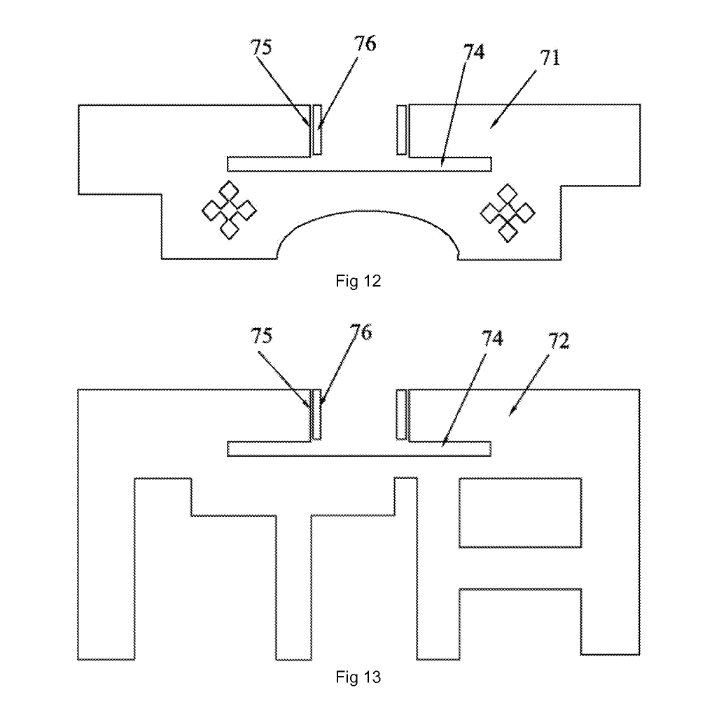

As shown in FIG. 10 and FIG. 11, this embodiment discloses the structure of a lighting lamp. The lighting lamp 6 comprises a frame 61, a light guide plate 62 and light source (not shown in the figure).

The light guide plate 62 is formed by splicing multiple sub-LGPs 621 which comprises a light source portion 6211 that is opposite to the light source and a light shield installation slot 6212 that is sunken inwards and arranged beside the light source portion. A light source slot 622, which is vertically sunken inwards, is arranged at middle of the upper surface of the sub-LGP. The light source portion is arranged at lateral side of the light source slot, and the light shield installation slots are horizontally arranged at bottom of the light source slot. The light source is opposite to the light source portion. A vertical supporting edge 611 that is inserted into the light source slot and a light shield edge 612 that is matched with and inserted into the light shield installation slot and arranged at bottom of the supporting edge are arranged at center of the bottom of the frame 61; the supporting edge 611, the light shield edge 612 and bottom 613 of the frame form the light shield that covers the light source. In this embodiment, because of the clever design of frame, it is unnecessary to design the light shield separately, which results in simplified structure, reduced material consumption and cost, and convenient splicing and assembling.

Because of the light shield installation slot, when it is necessary to splice the sub-LGPs together, it is only necessary to sleeve the light shield installation slot of each sub-LGP onto the light shield, which makes the splicing much easier; besides, different kinds of sub-LGPs can also be spliced together without any gap therebetween.

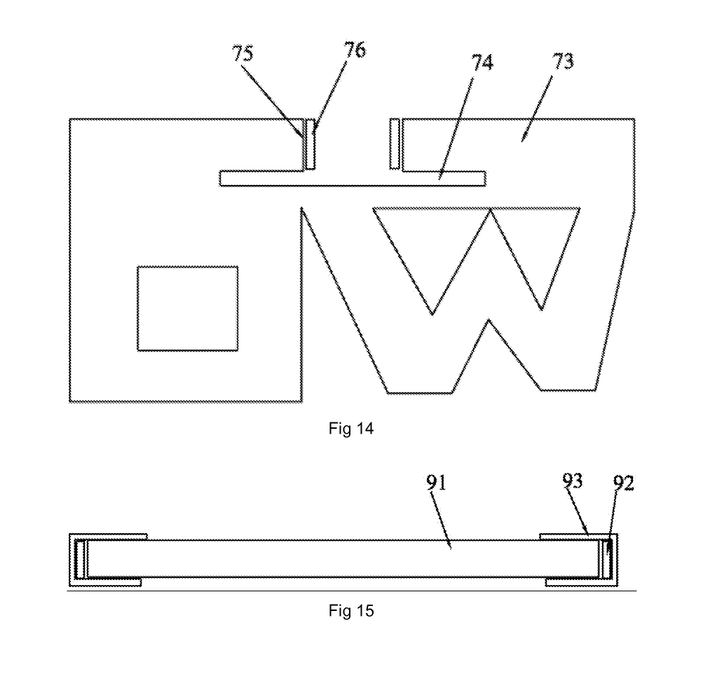

The light guide plate can be formed by splicing same sub-LGPs together, as shown in FIG. 10. Or it can be formed by splicing at least two different kinds of sub-LGPs together. The sub-LGPs can be of different structures to realize different lighting effects. For example, the sub-LGP can be formed by splicing the sub-LGP 71 as shown in FIG. 12, the sub-LGP 72 as shown in FIG. 13, and the sub-LGP 73 as shown in FIG. 14 together. In these three kinds of sub-LGPs, the arrangement of light shield installation slot 74, the light source portion 75 and the light source 76 is the same as the structure of FIG. 8, and the differences are the shape of each sub-LGP and other structures (such as carved pattern).

Because the light guide plate of the utility model can be formed by splicing multiple sub-LGPs quickly, one more advantage of the utility model is that the leftover materials of the existing technology of producing the integrated light guide plate can be used to manufacture small sub-LGPs, and then the light guide plate can be formed by splicing these small sub-LGPs together. As a result, it saves resources, avoids waste, improves the material utilization and reduces cost.

In the utility model, the light guide plate comprises at least one sub-LGP, and a light shield installation slot is arranged on the sub-LGP. In actual use, one edge of the light shield is inserted into the light shield installation slot, thus the light shield of the lighting lamp does not extend out of the light guide plate, so the light guide plate does not have any frame, which results in better appearance and light emitting effect. Because of the light shield installation slot, when it is necessary to splice the sub-LGPs together, it is only necessary to sleeve the light shield installation slot of each sub-LGP onto the light shield, which makes the splicing much easier; besides, different kinds of sub-LGPs can also be spliced together without any gap there between.

The utility model solves the frame problem of the light guide plate, realizes non-frame connection, and changes the old conception that the lighting through light guide plate is plane; and it can be applied more widely. By using the utility model, the light guide plate is three-dimensional with high artistry and ornamental value, as well as improved luminous efficiency; besides, it is more energy-saving and environment-friendly. The utility model can be used for different lighting purposes; for example, art illumination, decorative illumination, luminous brick, show window, cabinet, and display stand and so on.

The above is only description of the preferred embodiments, but not intended to limit the utility model. Any modification, identical replacement and improvement within the spirit and principle of the utility model shall belong to the protective scope of the utility model.

1. A light guide plate (LGP), comprising at least one sub-LGP, wherein the sub-LGP comprises at least one light source portion that is opposite to the light source, and the sub-LGP further comprises at least one light shield installation slot that is sunken inwards and arranged beside the light source portion.

2. The light guide plate according to claim 1, wherein the light source portion and the light shield installation slot are arranged at the lateral side of the sub-LGP.

3. The light guide plate according to claim 2, wherein there are at least two light shield installation slots that are respectively arranged at two sides of the light source portion.

4. The light guide plate according to claim 2, wherein there are at least two light source portions that are arranged at the sub-LGP side, and there are at least three light shield installation slots that are respectively arranged outside of the two light source portions and between the two light source portions.

5. The light guide plate according to claim 1, wherein a light source slot, which is vertically sunken inwards, is arranged at middle of the upper surface of the sub-LGP, the light source portion is arranged at lateral side of the light source slot, and the light shield installation slots are horizontally arranged at bottom of the light source slot.

6. The light guide plate according to claim 1, wherein the light guide plate is formed by splicing the sub-LGPs.

7. The light guide plate according to claim 6, wherein the light guide plate comprises at least two different kinds of sub-LGPs.

8. A lighting lamp, comprising a light source and a light guide plate (LGP), wherein the light guide plate comprising at least one sub-LGP, the sub-LGP comprises at least one light source portion that is opposite to the light source, and the sub-LGP further comprises at least one light shield installation slot that is sunken inwards and arranged beside the light source portion, and the light source is opposite to the light source portion.

9. The lighting lamp according to claim 8, wherein the lighting lamp further comprises a light shield that is opposite to the light source portion and covers the light source, and the light shield comprises a light shield edge that is matched with and inserted into the light shield installation slot.

10. A lighting lamp, comprising a light source and a light guide plate (LGP), wherein the light guide plate comprises at least one sub-LGP which comprises at least one light source portion that is opposite to the light source, and the sub-LGP further comprises at least one light shield installation slot that is sunken inwards and arranged beside the light source portion; a light source slot, which is vertically sunken inwards, is arranged at middle of the upper surface of the sub-LGP, the light source portion is arranged at lateral side of the light source slot, and the light shield installation slots are horizontally arranged at bottom of the light source slot; the light guide plate is formed by splicing the sub-LGPs; the light source is opposite to the light source portion; the lighting lamp further comprises a frame, and a vertical supporting edge that is inserted into the light source slot and a light shield edge that is matched with and inserted into the light shield installation slot and arranged at bottom of the supporting edge are arranged at center of the bottom of the frame; the supporting edge, the light shield edge and bottom of the frame form the light shield that covers the light source.

11. The lighting lamp according to claim 8, wherein the light source portion and the light shield installation slot are arranged at the lateral side of the sub-LGP.

12. The lighting lamp according to claim 8, wherein there are at least two light shield installation slots that are respectively arranged at two sides of the light source portion.

13. The lighting lamp according to claim 8, wherein there are at least two light source portions that are arranged at the sub-LGP side, and there are at least three light shield installation slots that are respectively arranged outside of the two light source portions and between the two light source portions.

14. The lighting lamp according to claim 8, wherein a light source slot, which is vertically sunken inwards, is arranged at middle of the upper surface of the sub-LGP, the light source portion is arranged at lateral side of the light source slot, and the light shield installation slots are horizontally arranged at bottom of the light source slot.

15. The lighting lamp according to claim 8, wherein the light guide plate is formed by splicing the sub-LGPs.

16. The lighting lamp according to claim 8, wherein the light guide plate comprises at least two different kinds of sub-LGPs.
